(19) United States
(12) Patent Application Publication
(10) Pub. No.: US 2015/0134443 A1
(43) Pub. Date: May 14, 2015

(54) TESTING A MARKETING STRATEGY OFFLINE USING AN APPROXIMATE SIMULATOR

(71) Applicant: Adobe Systems Incorporated, San Jose, CA (US)

(72) Inventors: Assaf Hallak, Tel Aviv (IL); Georgios Theocharous, San Jose, CA (US)

(73) Assignee: Adobe Systems Incorporated, San Jose, CA (US)

(21) Appl. No.: 14/080,038

(22) Filed: Nov. 14, 2013

(51) Int. Cl. G06Q 30/02

(52) U.S. Cl. CPC G06Q 30/0242
USPC 705/14.41

(57) ABSTRACT

In various example embodiments, a system and method for testing marketing strategies and approximate simulators offline for lifetime value marketing. In example embodiments, real world data, simulated data, and one or more policies that resulted in the simulated data are obtained. Errors between the real world data and the simulated data are determined. Using the determined errors, bounds are determined. Simulators are ranked based on the determined bounds, whereby a lower bound indicates a first simulator providing simulated data closer to the real world data then a second simulator having a higher bound.

### FIELD

The present disclosure relates generally to data processing, and in a specific example embodiment, to testing a marketing strategy offline using an approximate simulator.

### BACKGROUND

Conventionally, marketing applications are used by organizations to interact with their customers and provide recommendations. For example, a store may present customers with discount coupons, promotions, or targeted “on sale now” offers. In another example, a bank may email appropriate customers new loan or mortgage offers. These marketing decisions and recommendations are made mainly in a myopic approach (i.e., best opportunity right now is presented agnostic of the future) and only optimizes short-term gains. That is, the myopic approach only looks one step ahead in a marketing equation (e.g., what to present now to get the user to perform an immediate action only). Thus, these convention applications may only determine which advertisement to show to a customer so that the customer will respond to the immediate advertisement with a highest probability. However, these conventional marketing applications only look one step into the future in providing these recommendations and neglects lifetime value marketing.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to test a marketing strategy offline using an approximate simulator.

FIG. 2 is a block diagram illustrating an example embodiment of an evaluation system.

FIG. 3A is a diagram illustrating the various data processed and output by components for the evaluation system.

FIG. 3B is a graph illustrating differences between real world data and simulated data in accordance with one example.

FIG. 4 is a flow diagram of an example high-level method for testing results of a marketing strategy offline using an approximate simulator.

FIG. 5 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for testing marketing strategies and approximate simulators offline for lifetime value marketing. In example embodiments, an evaluation system which, given offline marketing data (e.g., real world data indicating a number of actual interactions of a user) from a system of an entity) and simulated data (indicating a number of simulated interactions) from a simulator that imitates the system of the entity, finds a bound between the simulator's cumulative number of simulated interactions (e.g., clicks or responses by a user as well as non-selections by the user) and a number of actual interactions in the offline data. For each interaction (also referred to as a “reward”) and transition to a next set of information based on the interaction, an estimate of a difference between the actual system and the simulator may be determined. Thus, a reward may be one when a user clicks on given information and the reward is zero when the user does not click on any information. An error (e.g., the difference) in each prediction of the simulator versus the offline data may be used to bound the error in an expected number of interactions for the user (e.g., a customer of the entity). The errors or differences are used to bound a lifetime difference in the number of interactions for the user (e.g., bound a lifetime difference between the number of actual interactions and the number of simulated interactions). Using the bounds, a choice of a strategy or simulator may be validated or selected. Additionally, actual bounds on how well the strategy or simulator will work in practice may be determined. This allows testing of marketing strategies without actually applying the strategies on the system of the entity.

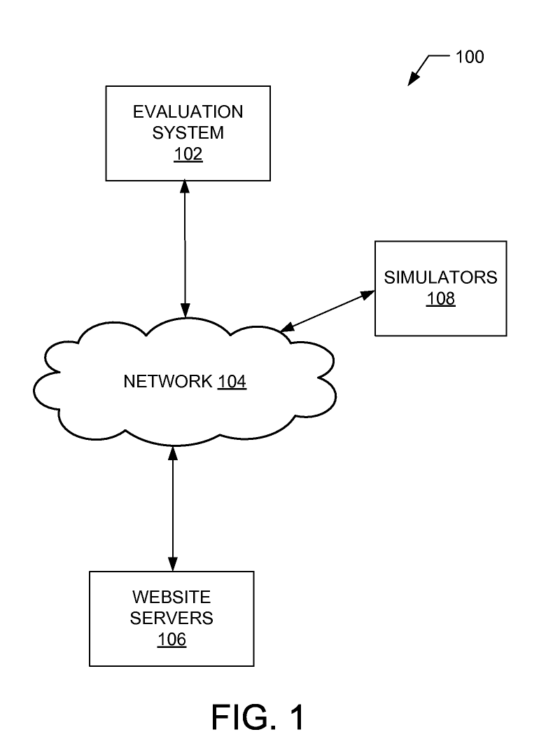

With reference to FIG. 1, an example embodiment of a high-level client-server-based network architecture 100 in which embodiments of the present invention may be utilized is shown. An evaluation system 102 is coupled via a communication network 104 (e.g., the Internet, wireless network, cellular network, Local Area Network (LAN), or a Wide Area Network (WAN)) to one or more website servers 106 and one or more simulators 108.

The evaluation system 102 manages the testing of strategies (also referred to as “policies”) and simulators 108. Policies indicate what to show and how often to show particular information (e.g., series of information) to a user in order to maximize the simulated number of interactions, a series of interactions, or rewards. The policy may comprise a mapping from every possible situation of the user to some information (e.g., advertisement offer) and provide guidelines or predictions as to information (e.g., a series of information) to provide along each step in time to maximum probability of success (e.g., to get the user to make a purchase).

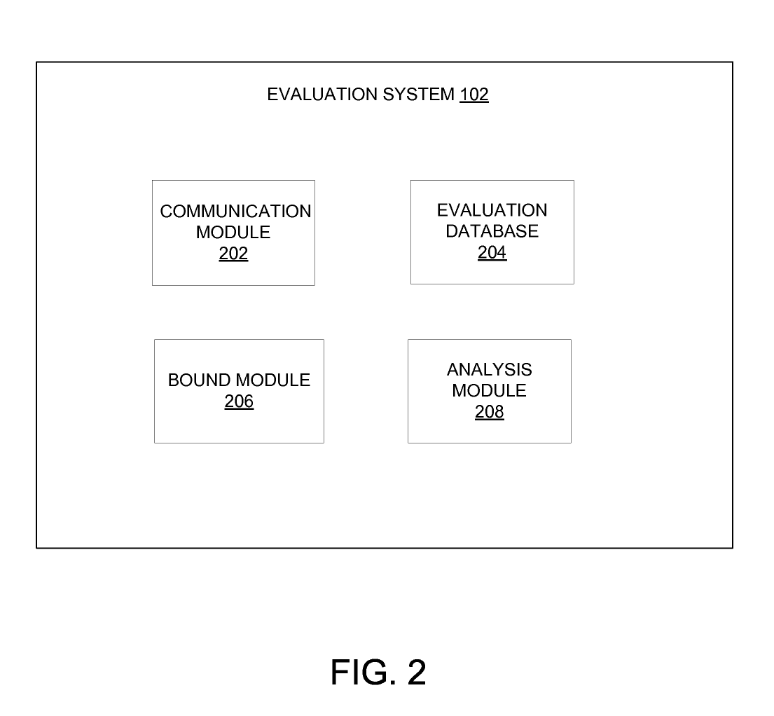

Accordingly, the evaluation system 102 may determine an optimal strategy, simulator, or a combination of both that will result in a highest number of interactions by one or more users. In example embodiments, the evaluation system 102 is embodied on a server and allows an administrator (e.g., of a website) to test the policies and simulators 108. The policies specify rules or conditions that a website may follow in order to provide recommendations or series of information to the users that will result in the user performing a plurality of actions on the website. The evaluation system 102 will be discussed in more detail in connection with FIG. 2 below.

The website servers 106 are each associated with an entity that publishes a website that desires to test their policies and/or simulators to determine, for example, an optimal policy or an optimal simulator to apply to their website. In example embodiments, the website servers 106 may provide real world data to the evaluation system 102 to be compared to simulator data received from the simulators 108. The real world data may comprise, for example, actual policies implemented by the website servers 106 and logged (actual) user interactions based on information provided in accordance with the actual policies.

The simulators 108 are configured to produce simulated results (also referred to as “simulated data”) that recommend or predict a series of information to be present to a user of a website that may cause the user to continually interact with the series of information (to maximize the simulated number of interactions). The simulated data may be a result of applying one or more policies to one or more simulators 108. The simulated results may use one or more of metadata known for the user, history of communications with each of the users, information probed by the user, and whether the user interacted with any information in applying a policy to the simulator 108. It is noted that, in some embodiments, the simulators 108 may be embodied within the website servers 106 or be located at a facility associated with the entity that publishes the website. In other embodiments, the simulators 108 may be associated with the evaluation system 102.

Example embodiments determine policies and/or simulators that optimize lifetime value marketing. Lifetime value marketing attempts to predict a series of information to provide to the user that will maximum the number of interactions (e.g., click-throughs, purchases, return visits, non-selection of items shown to the user) by the user. That is, lifetime value marketing attempts to build predicted models of the future that predicts what information to provide to the user now based on long term goals (e.g., to get the user to make a purchase, increase revenue, increase user satisfaction, or increase user loyalty). The policies may take into consideration user attributes and past history with an entity in order to determine what to show the user next to keep the user interacting with the entity.

Once a policy for the lifetime value marketing is developed, the entity will want to evaluate the strategy. Ideally, running the strategy (e.g., an algorithm that represents the strategy) in a real world environment (e.g., a website of the entity) would provide the best evaluation of the policy. However, running the policies in the real world environment is risky and potentially dangerous as the policies may not work well in the real world environment. The entity will not want to implement a policy on their website that may have negative effects on the entity's business.

As a result, the simulators 108 may be used offline to run the policies. The simulators 108 may be built to model behavior of the real world. For example, the simulators 108 may model users (e.g., customers) accessing a website provided by one of the website servers 106, showing the user's information, and predicting what the user will likely do next (e.g., click on a series of items, purchase a first item and later purchase a corresponding second item).

While the simulator 108 may be able to provide simulated results based on a particular policy, an entity may be interested in determining how close the simulated results are to real world results. That is, the entity may be interested in determining how good the policy or the simulator 108 really is compared to real world results. Accordingly, the evaluation system 102 provides a mechanism for testing the policies and the simulators 108 in an offline manner.

Referring to FIG. 2, an example block diagram illustrating multiple components that, in one embodiment, are provided within the evaluation system 102 is shown. In example embodiments, the evaluation system 102 comprises a communication module 202, an evaluation database 204, a bound module 206, and an analysis module 208. Some or all of the modules in the evaluation system 102 may be configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules.

The communication module 202 manages the exchange of information with both the website servers 106 and the simulators 108. In example embodiments, the communication module 202 may receive or obtain real world data from the website servers 106. The real world data comprises actual data of past policies used, information presented, and user interactions in response to policies (e.g., previously applied policies). The communication module 202 also receives, from the simulators 108, simulated data along with one or more policies tested using the simulators 108. Once the evaluation of the policies or a simulator 108 is completed, the communication module 202 may return the results to the entity (e.g., at the website server 106).

The evaluation database 204 may store (either temporarily or in a more permanent manner), the data received from the communication module 202 as well as results from the evaluation. As such, the evaluation database 204 may store, for example, policies and simulated data from the simulators 108 based on the policies along with real world data provided by an entity (e.g., data from a website of the entity). The real world data may comprise the actual information presented to the user, interactions by the user (.e.g., number of interactions based on a series of information presented), and a final goal (e.g., user purchase)

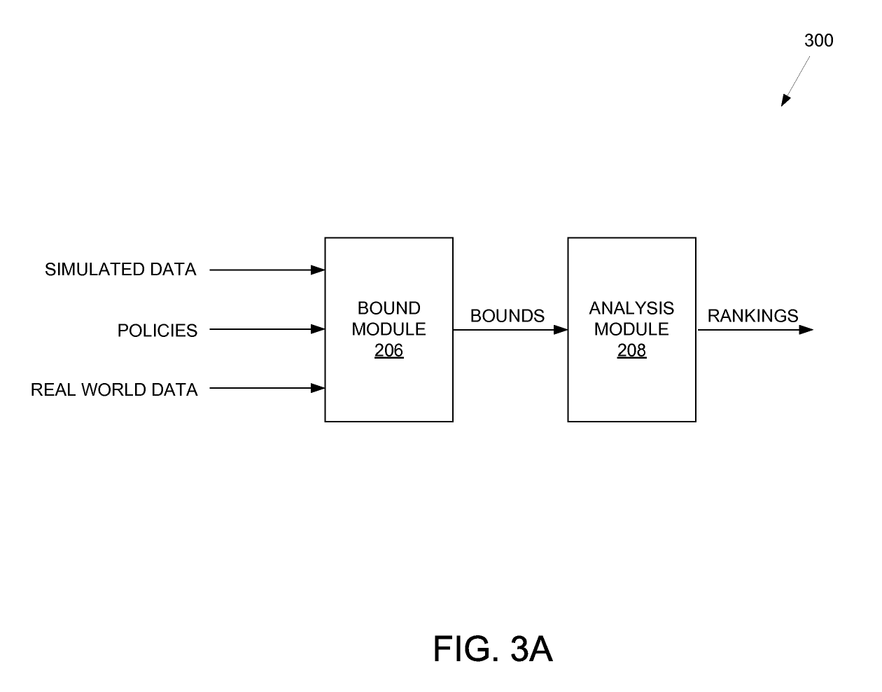

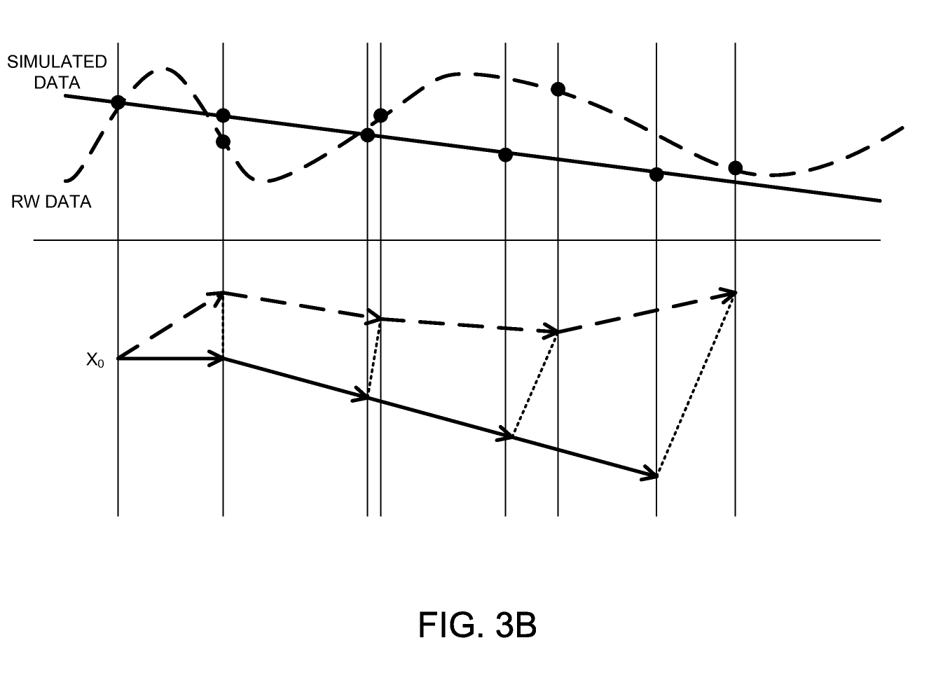

The bound module 206 performs an analysis of the simulated data versus actual data to determine bounds for a lifetime value of a particular policy, simulator, or both. The bounds are based on errors in the prediction (e.g., simulated data) compares to the real world data. The bound module 206 will be discussed in more detail in connection with FIG. 3 below.

The analysis module 208 analyzes the errors and bounds determined by the bound module 206 to rank or recommend policies or simulators. Accordingly, if the errors between the real world data and the simulated data (or resulting bound) are lower for a first simulator, for example, then the first simulator may be ranked higher (e.g., more highly recommended) than a second simulator with a higher error or bound. Similarly, a first policy that provides less error (e.g., has a lower bound) may be ranked higher than a second policy that produces a higher error or bound. In this way, the entity may be able to, for example, select a policy from a ranked or ordered list of policies presented to the entity to apply to their website or select a simulator from a ranked or ordered list of simulators presented to the entity with which to run future policies.

Although the various components of the evaluation system 102 have been defined in terms of a variety of individual modules, a skilled artisan will recognize that many of the items can be combined or organized in other ways and that not all modules need to be present or implemented in accordance with example embodiments. Furthermore, not all components of the evaluation system 102 may have been included in FIG. 2. In general, components, protocols, structures, and techniques not directly related to functions of exemplary embodiments have not been shown or discussed in detail. The description given herein simply provides a variety of exemplary embodiments to aid the reader in an understanding of the systems and methods used herein.

FIG. 3A is a diagram illustrating the various data processed and output by components of the evaluation system 102. As shown, the bound module 206 takes in simulated data, policies, and real world data. The simulated data and a corresponding policy used to generate the simulated data may be received from the simulator 108, while the real world data is received from the website server 106 of an entity that desires to test the accuracy of the policy or the simulator.

The bound module 206 determines differences between the real world data and the simulated data. As discussed, the reward comprises an interaction performed by the user (e.g., clicks or non-selections), whereas dynamics comprise a compact representation of the data available on the user (e.g., age, geographic location or number of clicks so far). The output of the bound module 206 may comprise four errors between the real world data and the simulated data. The errors may include (1) the difference between the true reward function and the estimated reward function, denoted as δ₁; (2) the smoothness of the reward function, denoted as α and δ₂; (3) the difference between the true dynamics and the estimated dynamics denoted as ε₁; and (4) the smoothness of the dynamics, denoted as ε₂ and β. The smoothness parameters α and β directly relate to the Lipschitz continuity of the corresponding reward and dynamic functions, which in fact limits how much these functions can change for small perturbations of the input. The parameters δ₂, ε₂ allow the usage of more varied distance functions between the true and estimated functions. The above mentioned error bounds can be computed recursively when evaluating future rewards to produce an analytic bound.

More specifically, when the true reward and dynamics are given by:

x(t)=f(x(t−1)),r(x)=g(x),

and the simulator's reward and dynamics are given by:

x(t)=\hat{f}(x(t−1)),r(x)=\hat{g}(x),

the aforementioned errors are in fact any parameters satisfying the following equations:

|g(x)−\hat{g}(x)|≦δ₁,|g(x)−\hat{g}(y)|≦α|x−y|+δ₂

|f(x)−\hat{f}(x)|≦ε₁,|f(x)−\hat{f}(y)|≦β|x−y|+ε₂

Although this formulation is only true for the simple deterministic case, it is very similar to when stochasticity is involved. The lifetime value bound is therefore:

$$\vert V - V \vert \leq \frac{γα ( {ɛ}_{1} + {ɛ}_{2} )}{( 1 - γ ) ( 1 - βγ )} + \frac{{δ}_{1} + {δ}_{2}}{1 - γ} ,$$

where γ is the discount factor commonly used in infinite horizon problems.

FIG. 3B is a graph illustrating differences between real world data and simulated data in accordance with one example. As shown, the real world data and the simulated data start off showing the same information. The bound module 206 determines a difference between the two sets of data (e.g., difference in the number of clicks or interactions). Over time, the points in space will change (e.g., the dynamics will change). For the first point in space (displaying a first set of information), there is a same probability for an interaction. Then, based on the policy, a second point (e.g., a second set of information) is provided and so forth. Over time, the points between the two sets of data diverge. This divergence is the error between the simulated data and the real world data. Error will propagate to a success function. In order to determine how bad the error/prediction is, an upper bound is determined. Thus, example embodiments use errors to bound the lifetime value, whereby a calculated error provides a calculated bound.

As such, the bound may be based on the four errors. In accordance with one embodiment, the bound may be mathematically derived as follows. For example, for some parameters u, v consider the following real system:

$$x ( t ) = x ( t - 1 ) + v = x ( t - 2 ) + 2 v = … = 1 + ( t - 1 ) v$$

$$V = {\sum }_{t = 0}^{∞} {γ}^{t} r ( t ) = {\sum }_{t = 0}^{∞} {γ}^{t} exp ( - u \cdot x ( t ) ) = {\sum }_{t = 0}^{∞} {γ}^{t} exp ( - u \cdot ( 1 + ( t - 1 ) v ) )$$

$$V = \frac{exp ( uv - u )}{1 - γ exp ( - uv )}$$

where x(t) is the state at time t, γ is a discount factor that prevents explosion of value for an infinite reward, and V is the lifetime value.

For two estimates of u, v denoted as û, \hat{v}, a simulated system may be indicated as for example,

$$x ( t ) = x ( t - 1 ) + \hat{v} = x ( t - 2 ) + 2 \hat{v} = … = 1 + ( t - 1 ) \hat{v}$$

$$V = {\sum }_{t = 0}^{∞} {γ}^{t} r ( t ) = {\sum }_{t = 0}^{∞} {γ}^{t} exp ( - \hat{u} \cdot x ( t ) ) = {\sum }_{t = 0}^{∞} {γ}^{t} exp ( - \hat{u} \cdot ( 1 + ( t - 1 ) \hat{v} ) )$$

$$V = \frac{exp ( \hat{u} \hat{v} - \hat{u} )}{1 - γ exp ( - \hat{u} \hat{v} )}$$

where γ is a discount factor that prevents explosion of value for an infinite reward.

The bound may be calculated by:

δ₂=|exp(−u)−exp(−\hat{u})|—Relate to the difference between the two reward functions

α=exp(−u),δ₁=0—Relate to the smoothness of the reward function r(x)=exp(−ux)

ε₂=|v−\hat{v}|—Relate to the difference in the dynamics

β=1,ε₁=0—Relate to the smoothness of the dynamics x(t)=x(t−1)+v

$$\vert V - V \vert \leq \frac{γα ( {ɛ}_{1} + {ɛ}_{2} )}{( 1 - γ ) ( 1 - βγ )} + \frac{{δ}_{1} + {δ}_{2}}{1 - γ} = \frac{\vert v - \hat{v} \vert exp ( - u ) γ}{{( 1 - γ )}^{2}} + \frac{\vert exp ( - u ) - exp ( - \hat{u} ) \vert}{1 - γ}$$

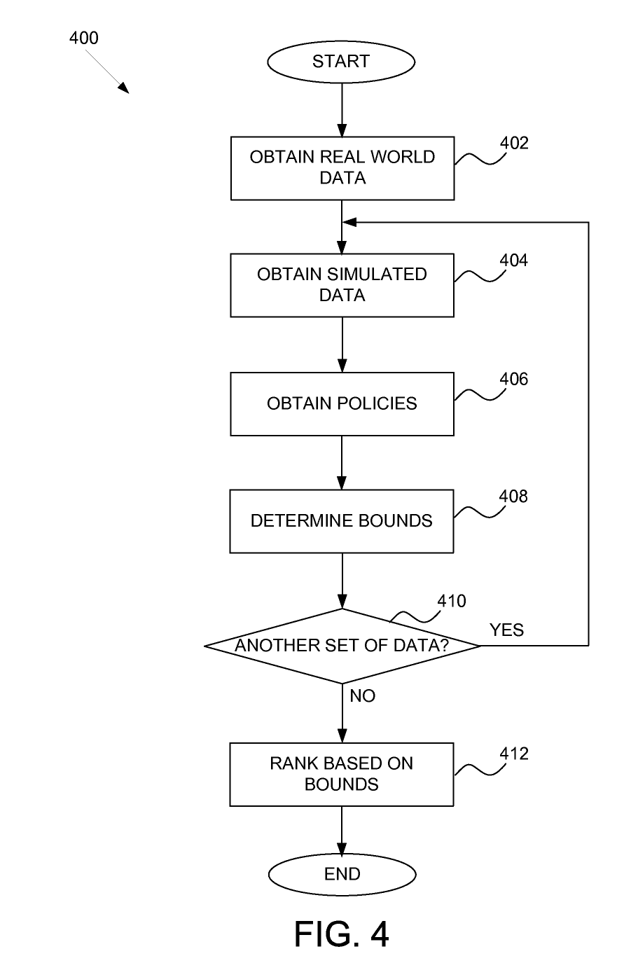

FIG. 4 is a flow diagram of an example high-level method 400 for testing policies or simulators. In operation 402, real world data is obtained from an entity. The real world data comprises actual data regarding a series of information shown to a user and user interactions with the series of information. For example, 100 items or steps are shown to the user and the user interacted with six of the items.

In operation 404, simulated data is obtained from the simulator. In example embodiments, the simulator 108 simulates one or more policies for an entity given user attributes for a user of a website or system of the entity. Along with the simulated data, policies are obtained in operation 406. These policies may comprise the policies used by the simulators in creating the simulated data.

Bounds are determined in operation 408 by, for example, the bound module 206. The bounds are based on errors determined between the real world data and the simulated data for a particular policy. The lower the errors and bounds, the more accurate the simulator or the policy is compared to a real world environment (e.g., closer to real world environment or data).

In operation 410, a determination is made as to whether another set of simulated data is available for testing. If another set of simulated data is available, then the method 400 returns to operation 404. For example, if the evaluation system 102 is testing different simulators to determine an optimal simulator for the website of the entity, the evaluation system 102 may test simulated results for a same policy across different simulators. Alternatively, if the evaluation system 102 is testing different policies to determine an optimal policy, the evaluation system 102 may test a plurality of policies using a same simulator. As such, the method returns to operation 404 to obtain a next set of simulated data to compare to the real world data.

However, if no further set of simulated data is available for testing, rankings are determined in operation 412. The analysis module 208 ranks the simulator or the policy based on the determined bounds. If the bound is lower, than the simulator or the policy is ranked higher (e.g., is more accurate and closer to a real world environment). Thus, the analysis module 208 may create a ranked or ordered list of simulators or policies in ascending order of calculated bounds that is presentable to a user. In other words, simulators or policies may be ranked based on the determined bound whereby the lower the bound, the higher the simulator or policy is ranked (e.g., ranking the simulators or policies from lowest bounds to highest bounds). The ranking of the simulators or policies may then be presented to the user from which the user may select a simulator or a policy for future use.

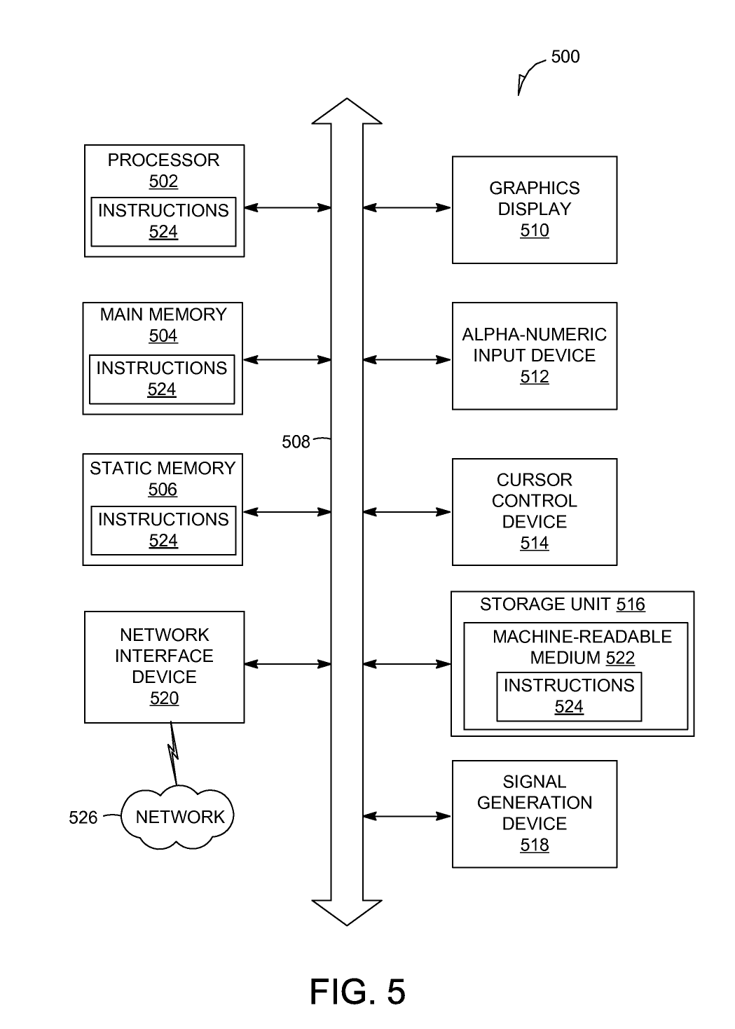

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system and within which instructions 524 (e.g., software, a program, an application, an applet, an app, or other executable code) for causing the machine 500 to perform any one or more of the methodologies discussed herein may be executed. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The machine 500 may further include a graphics display 510 (e.g., a plasma display panel (PDP), a light emitting diode (LED) display, a liquid crystal display (LCD), a projector, or a cathode ray tube (CRT)). The machine 500 may also include an alphanumeric input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a speaker), and a network interface device 520.

The storage unit 516 includes a machine-readable medium 522 on which is stored the instructions 524 embodying any one or more of the methodologies or functions described herein. The instructions 524 may also reside, completely or at least partially, within the main memory 504, within the processor 502 (e.g., within the processor's cache memory), or both, during execution thereof by the machine 500. Accordingly, the main memory 504 and the processor 502 may be considered as machine-readable media. The instructions 524 may be transmitted or received over a network 526 via the network interface device 520.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 500), such that the instructions, when executed by one or more processors of the machine (e.g., processor 502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. Furthermore, the machine-readable medium is non-transitory in that it does not embody a propagating signal. However, labeling the machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 524 may further be transmitted or received over a communications network 526 using a transmission medium via the network interface device 520 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method for testing policies and simulators offline for lifetime value marketing, the method comprising:
obtaining real world data indicating a number of actual interactions of a user, simulated data indicating a number of simulated interactions, and one or more policies that resulted in the simulated data, the simulators and the one or more policies used to predict a series of information to provide to the user to maximize the number of actual interactions by the user;
determining errors between the real world data and the simulated data, the errors being used to bound a lifetime difference between the number of actual interactions and the number of simulated interactions;
determining, using a hardware processor, bounds using the determined errors; and
ranking the simulators based on the determined bounds, a lower bound indicating a first simulator providing simulated data closer to the real world data than a second simulator having a higher bound.

2. The method of claim 1, wherein the ranking comprises ranking the simulators from lowest bounds to highest bounds, each simulator recommending the series of information to present to the user to maximize the simulated number of interactions.

3. The method of claim 1, further comprising:
presenting the ranking of the simulator to a user; and
allowing the user to select one of the simulators for future use, each simulator recommending the series of information to present to the user to maximize the simulated number of interactions.

4. The method of claim 1, further comprising ranking the one or more polices based on the determined bounds, a lower bound indicating a first policy providing simulated data closer to the real world data than a second policy having a higher bound, each policy indicating what information to show and how often to show the information in order to maximize the simulated number of interactions.

5. The method of claim 4, wherein the ranking comprises ranking the one or more policies from lowest bounds to highest bounds.

6. The method of claim 4, further comprising:
presenting the ranking of the policies to a user; and
allowing the user to selecting one of the policies for future use.

7. The method of claim 1 wherein the bounds are based on at least a selection of a type of error from the group consisting of:
a difference between a true reward function and an estimated reward, δ₁;
a smoothness of the reward functions, α and δ₂;
a difference between true dynamics and estimated dynamics, ε₁; and
a smoothness of dynamics, ε₂ and β.

8. The method of claim 1, further comprising applying the one or more policies to one or more simulators to obtain the simulated data.

9. A non-transitory machine-readable medium in communication with at least one processor, the non-transitory machine-readable medium storing instructions which, when executed by the at least one processor of a machine, causes the machine to perform operations comprising:
obtaining real world data indicating a number of actual interactions of a user, simulated data indicating a number of simulated interactions, and one or more policies that resulted in the simulated data, the simulators and the one or more policies used to predict a series of information to provide to the user to maximize the number of actual interactions by the user;
determining errors between the real world data and the simulated data, the errors being used to bound a lifetime difference between the number of actual interactions and the number of simulated interactions;
determining bounds using the determined errors; and
ranking simulators based on the determined bounds, a lower bound indicating a first simulator providing simulated data closer to the real world data than a second simulator having a higher bound.

10. The non-transitory machine-readable medium of claim 9, wherein the ranking comprises ranking the simulators from lowest bounds to highest bounds, each simulator recommending the series of information to present to the user to maximize the simulated number of interactions.

11. The non-transitory machine-readable medium of claim 9, further comprising:
presenting the ranking of the simulator to a user; and
allowing the user to select one of the simulators for future use, each simulator recommending the series of information to present to the user to maximize the simulated number of interactions.

12. The non-transitory machine-readable medium of claim 9, further comprising ranking the one or more polices based on the determined bounds, a lower bound indicating a first policy providing simulated data closer to the real world data than a second policy having a higher bound, each policy indicating what information to show and how often to show the information in order to maximize the simulated number of interactions.

13. The non-transitory machine-readable medium of claim 12, wherein the ranking comprises ranking the one or more policies from lowest bounds to highest bounds.

14. The non-transitory machine-readable medium of claim 12, further comprising:
presenting the ranking of the policies to a user; and
allowing the user to selecting one of the policies for future use.

15. The non-transitory machine-readable medium of claim 9 wherein the bounds are based on at least a selection of a type of error from the group consisting of:
a difference between a true reward function and an estimated reward, δ₁;
a smoothness of the reward functions, α and δ₂;
a difference between true dynamics and estimated dynamics, ε₁; and
a smoothness of dynamics, ε₂ and β.

16. The non-transitory machine-readable medium of claim 9, further comprising applying the one or more policies to one or more simulators to obtain the simulated data.

17. A system comprising:
A hardware processor of a machine;
a communication module to obtain real world data indicating a number of actual interactions of a user, simulated data indicating a number of simulated interactions, and one or more policies that resulted in the simulated data, the simulators and the one or more policies used to predict a series of information to provide to the user to maximize the number of actual interactions by the user;
a bounding module to determine errors between the real world data and the simulated data, and to determine, using the hardware processor, bounds using the determined errors, the errors being used to bound a lifetime difference between the number of actual interactions and the number of simulated interactions; and
an analysis module to rank simulators based on the determined bounds, a lower bound indicating a first simulator providing simulated data closer to the real world data than a second simulator having a higher bound.

18. The system of claim 17, wherein the analysis module ranks the simulators by ranking the simulators from lowest bounds to highest bounds, each simulator recommending the series of information to present to the user to maximize the simulated number of interactions.

19. The system of claim 17, wherein the analysis module is further to rank the one or more polices based on the determined bounds, a lower bound indicating a first policy providing simulated data closer to the real world data then a second policy having a higher bound, each policy indicating what information to show and how often to show the information in order to maximize the simulated number of interactions.

20. The system of claim 19, wherein the analysis module ranks the one or more policies from lowest bounds to highest bounds.
